(19) United States
(12) Patent Application Publication
(10) Pub. No.: US 2023/0029854 A1
(43) Pub. Date: Feb. 2, 2023

(54) SURFACE TREATMENT COMPOSITION FOR VIBRATION DAMPING STEEL SHEET AND VIBRATION DAMPING STEEL SHEET

(71) Applicant: POSCO, Pohang-si, Gyeongsangbuk-do (KR)

(72) Inventors: Jin-Tae Kim, Gwangyang-si, Jeollanam-do (KR); Jung-Hwan Lee, Pohang-si, Gyeongsangbuk-do (KR); Ha-Na Choi, Gwangyang-si, Jeollanam-do (KR); Yang-Ho Choi, Gwangyang-si, Jeollanam-do (KR)

(73) Assignee: POSCO, Pohang-si, Gyeongsangbuk-do (KR)

(21) Appl. No.: 17/787,036

(22) PCT Filed: Oct. 15, 2020
(86) PCT No.: PCT/KR2020/014101

§ 371 Date: Jun. 17, 2022

(30) Foreign Application Priority Data
Dec. 19, 2019 (KR) 10-2019-0170966

(51) Int. Cl. C09D 133/04; C09D 7/65; C09D 7/40

(52) U.S. Cl. CPC C09D 133/04; C09D 7/65; C09D 7/69

(57) ABSTRACT

The present disclosure is to provide a vibration damping steel sheet having improved vibration damping performance. According to the present disclosure, rubber particles are dispersed in a polymer resin to form a vibration damping layer, thereby providing a vibration damping steel sheet having improved vibration damping performance.

### TECHNICAL FIELD

The present disclosure relates to a surface treatment composition for a vibration damping steel sheet, and a vibration damping steel sheet.

### BACKGROUND ART

A vibration damping steel sheet, a steel sheet blocking external noise or vibrations, is used in various fields, for example, as outer plating of household appliances making a lot of noise such as a refrigerator, a washing machine, and an air purifier, automotive parts such as an engine oil pan and a dash panel, which are the main causes of car noise, precision instruments, building materials, and the like.

The vibration damping steel sheet generally includes a constrained vibration damping steel sheet manufactured by laminating a polymer resin between two steel sheets and a non-constrained vibration damping steel sheet in which a polymer resin is coated or laminated on one steel sheet, and the constrained vibration damping steel sheet and the non-constrained vibration damping steel sheet are different from each other in terms of a method of implementing vibration damping performance. External noise or vibrational energy is converted into thermal energy by shear deformation of the polymer resin laminated between steel sheets in the constrained vibration damping steel sheet ((a) of FIG. 1), or by stretch deformation of the polymer resin coated on a steel sheet in the non-constrained vibration damping steel sheet ((b) of FIG. 1).

As a conventional technology related to the vibration damping steel sheet, technologies using a polyester resin (Japanese Patent Laid-Open Publication No. (Sho) 51-93770), using a polyamide resin (Japanese Patent Laid-Open Publication No. (Sho) 56-159160), and using ethylene/α-olefin and crosslinked polyolefin (Japanese Patent Laid-Open Publication No. (Sho) 59-152847), are known in the art. Conventional technologies have implemented vibration damping performance using a viscoelastic effect of a polymer resin.

Meanwhile, as another conventional technology related to the vibration damping steel sheet, there is a technology in which a rubber sheet having excellent shock absorptive power is attached to a steel sheet. However, due to soft properties of rubber, it is difficult to maintain strength thereof when steel plates are joined to each other, and the rubber sheet may be easily peeled off or the rubber sheet may be destroyed during processing or when external force is applied, making it difficult to maintain vibration damping performance.

Under the background as such, the inventors of the present disclosure intended to improve vibration damping performance, thereby deriving the present disclosure.

### SUMMARY OF INVENTION

### Technical Problem

The purpose of the present disclosure is to provide a steel sheet surface treatment composition capable of improving vibration damping performance of a steel sheet.

### Solution to Problem

According to an aspect of the present disclosure, there is provided a surface treatment composition for a vibration damping steel sheet including 90 to 99% by weight of a polymer resin and 1 to 10% by weight of rubber particles with respect to the total weight of the composition, and the rubber particles are dispersed in the polymer resin.

According to another aspect of the present disclosure, there is provided a vibration damping steel sheet including a steel sheet and a vibration damping layer containing the composition on at least one surface of the steel sheet.

### Advantageous Effects of Invention

According to the present disclosure, a vibration damping layer is formed by dispersing rubber particles in a polymer resin when a vibration damping steel sheet is manufactured, thereby implementing a vibration damping steel sheet with improved vibration damping performance due to a toughening effect of the rubber particles.

### BRIEF DESCRIPTION OF DRAWINGS

FIG. 1 is diagrams illustrating a principle of blocking external vibrational energy of a conventional vibration damping steel sheet. In FIG. 1, (a) is a constrained vibration damping steel sheet, and (b) is a non-constrained vibration damping steel sheet.

FIG. 2 is a diagram illustrating vibrations or cracks occurring in a conventional vibration damping steel sheet when external force is applied thereto.

FIG. 3 is a diagram illustrating rubber particles absorbing vibrations when external force is applied to a vibration damping steel sheet according to the present disclosure.

FIG. 4 is a diagram illustrating a polymer resin in which rubber particles are dispersed according to the present disclosure.

FIG. 5 is diagrams illustrating vibration damping performance of (a) a steel sheet, (b) a conventional vibration damping steel sheet, and (c) a vibration damping steel sheet according to the present disclosure.

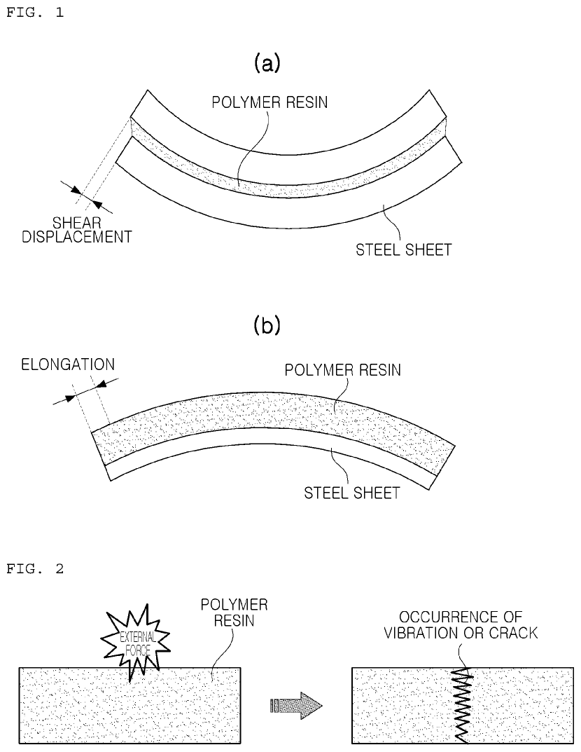

### BEST MODE FOR INVENTION

Hereinafter, preferred example embodiments of the present disclosure are described in detail. However, example embodiments of the present disclosure may be modified in various different forms, and the scope of the present disclosure should not be limited to the example embodiments set forth herein.

The present disclosure relates to a composition for surface treatment of a vibration damping steel sheet including a polymer resin and rubber particles. According to the present disclosure, a toughening effect of the rubber particles as well as a viscoelastic effect of the polymer resin itself may be used to implement vibration damping performance of the steel sheet, and further to implement vibration prevention performance.

The vibration damping steel sheet includes a constrained vibration damping steel sheet manufactured by laminating a polymer resin molded in the form of a film between two steel sheets and a non-constrained vibration damping steel sheet in which a polymer resin is coated or laminated on one steel sheet. The polymer resin applied to the vibration damping steel sheet has a viscoelastic effect, and converts vibrational energy into thermal energy by shear deformation or stretch deformation.

As a polymer resin usable in the present disclosure, in the case in which the polymer resin and rubber particles are mixed through a melt brand method, a thermoplastic resin such as an ethylene vinyl acetate resin, a polyethylene resin, a polypropylene resin, a polyvinyl butyral resin, or the like may be used. In addition, as a liquid polymer resin, a polyester resin, a polyvinyl chloride resin, an epoxy resin, or the like may be used.

Meanwhile, in the case in particles of the polymer are used solely in manufacturing of the vibration damping steel sheet, when external force, such as vibrations and noise, is excessively applied to the steel sheet, vibrations occur in a vibration damping layer due to brittle properties of the polymer resin, and further, a crack may occur (FIG. 2).

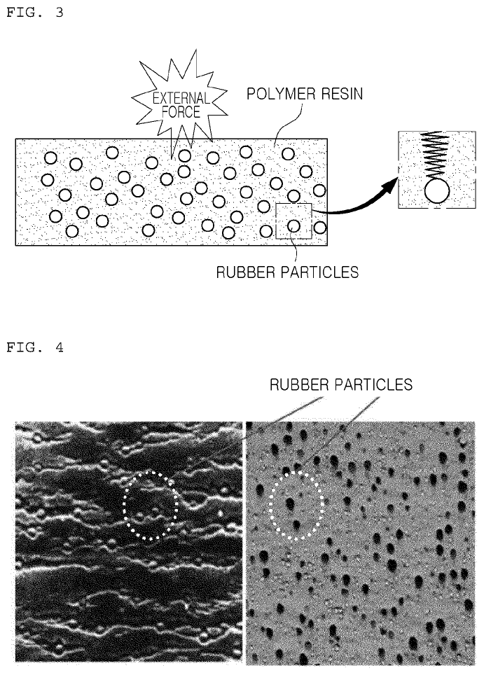

However, in the present disclosure, improved vibration damping performance may be implemented by mixing the polymer resin and the rubber particles. More specifically, in the present disclosure, after the polymer resin is melted by heating the polymer resin to a melting point thereof or higher, a vibration damping layer is formed by uniformly mixing the rubber particles with the polymer resin (melt brand method) or by dispersing the rubber particles in a liquid polymer resin. When the rubber particles are dispersed in the polymer resin as described above, the rubber particles absorb vibrations due to a toughening effect of the rubber particles even when external force is applied to the steel sheet. That is, the rubber particles absorb vibrations caused by external force while maintaining strength and a viscoelastic effect of the polymer resin, so that the vibrations are not transmitted to the polymer resin, and vibration damping performance may be improved compared to that of a vibration damping steel sheet using the polymer resin solely (FIGS. 3 and 4).

A surface treatment composition of the present disclosure may include 90 to 99% by weight of a polymer resin and 1 to 10% by weight of rubber particles with respect to the total weight of the composition. When a content of the rubber particles is less than 1% by weight, it may be difficult to implement vibration damping performance due to an excessive small amount of rubber particles. Conversely, when the content of the rubber particles exceeds 10% by weight, melt-flowability of the polymer resin caused by heat when using a thermoplastic resin is deteriorated due to an excessive large amount of rubber particles, making it difficult to uniformly mix the rubber particles and the polymer resin. In addition, in the case of a liquid polymer resin, solution stability is lowered and viscosity is increased, which may cause a process issue when coating a steel sheet. Furthermore, in the case in which the solution is prepared in the form of a film, the film has lowered toughness to be easily destroyed by external force.

In addition, the rubber particles may be one or more selected from the group consisting of nitrile-butadiene rubber (NBR), ethylene-propylene rubber (EPR), styrene-butadiene rubber (SBR), and natural rubber (NR), but are not limited thereto.

In addition, an average particle diameter of the rubber particles is not particularly limited, but the average particle diameters may be 0.1 mm or more in terms of convenience in manufacturing the rubber particles. Meanwhile, when the average particle diameter exceeds 1.5 mm, it is difficult to implement the rubber particles as a coating film, and thus an average particle diameter exceeding 1.5 is not preferable.

The surface treatment composition of the present disclosure may further include an additive which is generally used for steel sheet surface treatment, and for example, may further include a wetting agent, a defoaming agent, a crosslinking agent, an antioxidant, and the like.

Next, a vibration damping steel sheet having a vibration damping layer formed using the composition for surface treatment of a vibration damping steel sheet is described. The vibration damping layer may be formed by molding the composition into a film form and laminating the film, or applying a liquid composition, to at least one surface of a steel sheet. In addition, the vibration damping layer may be formed by molding the composition into a film form and laminating the film, or applying a liquid composition, between steel sheets.

In the case of the vibration damping layer molded into a film form, after the polymer resin is melted by heating the polymer resin to the melting point thereof or higher, the rubber particles are uniformly mixed therewith (melt brand method), and the mixture is molded into a film form. Mixing conditions may be appropriately adjusted depending on the melting point of the polymer resin, and the thickness of the film is preferably 25 to 300 μm. When a vibration damping layer molded into a film form is manufactured, an ethylene vinyl acetate resin, a polyethylene resin, a polypropylene resin, a polyvinyl butyral resin, and the like may be used as a preferred polymer resin.

Meanwhile, in the case in which the polymer resin is a liquid, an appropriate amount of rubber particles is uniformly mixed, and then the mixture is applied to have a thickness of 1 to 200 μm, thereby forming the vibration damping layer. In this case, a polyester resin, a polyvinyl chloride resin, an epoxy resin, and the like may be preferably used.

The steel sheet is not particularly limited in the present disclosure, but a cold rolled steel sheet, a hot rolled steel sheet, a galvanized steel sheet, a zinc alloy plated steel sheet, a stainless steel sheet, an aluminum plate, and the like may be used, and a metal plate may generally have a thickness of about 0.2 to 1.2 mm.

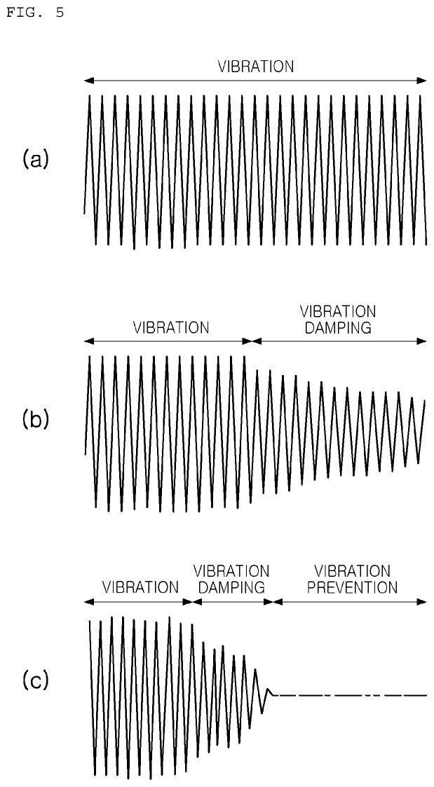

In the case in which the vibration damping steel sheet is manufactured by dispersing the rubber particles in the polymer resin according to the present disclosure, the rubber particles absorb vibrations while maintaining strength and viscoelasticity of the polymer resin, thereby improving vibration damping performance (FIG. 5).

### MODE FOR INVENTION

### Example

Hereinafter, the Examples of the present disclosure will be described in detail. The following Examples are only illustrative of the present disclosure, and do not limit the scope of the present disclosure.

1. Manufacturing of Coating Solution and Vibration Damping Steel Sheet for Forming Vibration Damping Layer

### (1) Example 1

1 g of NBR rubber particles having an average particle diameter of 1 mm were added to 99 g of a polyester resin, and then the mixture was uniformly dispersed at a speed of 3000 rpm in a high-speed agitator, thereby preparing a coating solution. The prepared coating solution was applied to a galvanized steel sheet to a thickness of 30 μm, and then was dried to manufacture a vibration damping steel sheet.

### (2) Example 2

A coating solution was prepared and a vibration damping steel sheet was manufactured in the same manner as that in Example 1, except that 97 g of a polyester resin and 3 g of NBR rubber particles were used.

### (3) Example 3

A coating solution was prepared and a vibration damping steel sheet was manufactured in the same manner as that in Example 1, except that 95 g of a polyester resin and 5 g of NBR rubber particles were used.

### (4) Example 4

A coating solution was prepared and a vibration damping steel sheet was manufactured in the same manner as that in Example 1, except that 93 g of a polyester resin and 7 g of NBR rubber particles were used.

### (5) Example 5

A coating solution was prepared and a vibration damping steel sheet was manufactured in the same manner as that in Example 1, except that 90 g of a polyester resin and 10 g of NBR rubber particles were used.

### (6) Comparative Example 1

A polyester resin was applied to a galvanized steel sheet to a thickness of 30 μm, and then was dried to manufacture a vibration damping steel sheet.

### (7) Comparative Example 2

A coating solution was prepared and a vibration damping steel sheet was manufactured in the same manner as that in Example 1, except that 99.9 g of a polyester resin and 0.1 g of NBR rubber particles were used.

2. Evaluation of Vibration Damping Performance

An acceleration sensor was attached to the vibration damping steel sheets manufactured in Examples and Comparative Examples, and vibrations were generated in a specimen using an impact hammer to collect electrical signal data. From the electrical signal data, vibrations were measured and analyzed, and a loss factor was measured. A loss factor value is represented by a ratio of energy lost as heat to the total vibration energy of one vibration cycle with respect to external impact.

$$Loss factor = \frac{Lost energy}{Total vibration energy of one vibration cycle}$$

TABLE 1

| | Rubber particle content | Loss |
|---|---|---|
| | (wt % ) | factor |
| Example 1 | 1 | 0.0083 |
| Example 2 | 3 | 0.01 |
| Example 3 | 5 | 0.013 |
| Example 4 | 7 | 0.017 |
| Example 5 | 10 | 0.02 |
| Comparative | 0 | 0.0071 |
| Example 1 | | |
| Comparative | 0.1 | 0.0075 |
| Example 2 | | |

1. A surface treatment composition for a vibration damping steel sheet, comprising:
90 to 99% by weight of a polymer resin and 1 to 10% by weight of rubber particles with respect to the total weight of the composition,
wherein the rubber particles are dispersed in the polymer resin.

2. The surface treatment composition for a vibration damping steel sheet of claim 1, wherein the polymer resin is one or more selected from the group consisting of an ethylene vinyl acetate resin, a polyethylene resin, a polypropylene resin, a polyvinyl butyral resin, a polyester resin, a polyvinyl chloride resin, and an epoxy resin.

3. The surface treatment composition for a vibration damping steel sheet of claim 1, wherein the rubber particles are one or more selected from the group consisting of nitrile-butadiene rubber (NBR), ethylene-propylene rubber (EPR), styrene-butadiene rubber (SBR), and natural rubber (NR).

4. The surface treatment composition for a vibration damping steel sheet of claim 1, wherein an average particle diameter of the rubber particles is greater than 0 and less than or equal to 1.5 mm.

5. A vibration damping steel sheet comprising:
a steel sheet, and a vibration damping layer containing the composition of claim 1 on at least one surface of the steel sheet.

6. The vibration damping steel sheet of claim 5, wherein the polymer resin is one or more selected from the group consisting of an ethylene vinyl acetate resin, a polyethylene resin, a polypropylene resin, a polyvinyl butyral resin, a polyester resin, a polyvinyl chloride resin, and an epoxy resin.

7. The vibration damping steel sheet of claim 5, wherein the rubber particles are one or more selected from the group consisting of nitrile-butadiene rubber (NBR), ethylene-propylene rubber (EPR), styrene-butadiene rubber (SBR), and natural rubber (NR).

8. The vibration damping steel sheet of claim 5, wherein an average particle diameter of the rubber particles is greater than 0 and less than or equal to 1.5 mm.
